(19) United States
(12) Patent Application Publication
(10) Pub. No.: US 2026/0109884 A1
(43) Pub. Date: Apr. 23, 2026

(54) BONDING A TERAHERTZ IMAGER TO A LENS TO PROVIDE AN OPTIMAL INTERFACE

(71) Applicant: TiHive, Grenoble (FR)

(72) Inventors: Victoria NASSERDDINE, Grenoble (FR); Hani SHERRY, Grenoble (FR); Carlos PRADA ROJAS, Grenoble (FR)

(21) Appl. No.: 18/997,476

(22) PCT Filed: Jul. 17, 2023
(86) PCT No.: PCT/FR2023/051104

§ 371 Date: Jan. 5, 2026

(30) Foreign Application Priority Data
Jul. 18, 2022 (FR) FR2207314

(51) Int. Cl. C09J 5/06; C09J 163/00; G01J 1/04

(52) U.S. Cl. CPC C09J 5/06; C09J 163/00; G01J 1/0411; C09J 2203/326; C09J 2463/00

(57) ABSTRACT

The invention relates to a method for assembling an optical device compatible with terahertz radiation, comprising the following steps: providing first and second silicon elements each having a planar face; depositing on the planar face of the first element an adhesive having the following characteristics: a) epoxy resin curable by heat, b) Brookfield viscosity CP51, 25° C., speed 5 rpm: 50000 mPa·s±20%, and c) absence of fillers to make the adhesive electrically or thermally conductive; and applying the planar face of the second element to the adhesive deposited on the planar face of the first element.

### TECHNICAL FIELD

The invention relates to optical systems used in terahertz imaging.

### BACKGROUND

A terahertz imager may comprise an array of sensors fabricated on a silicon chip using techniques employed for semiconductors. Such a chip is generally assembled in a module where it is associated with a silicon collimation lens. The lens is often hyper-hemispherical in shape, i.e. a sphere truncated to keep more than half of the sphere. The chip is preferably mounted in contact against the truncated face of the lens and centered on the optical axis of the lens.

This type of assembly presents certain difficulties, particularly concerning automation of the assembly and the optical quality of the interface between the chip and the lens.

### SUMMARY

An optical module for terahertz radiation is generally provided, comprising a support including a recess having a generally cylindrical wall opening onto a first face of the support, and an orifice centered on the cylindrical wall and passing through a bottom of the recess to a second face of the support; a lens arranged in the recess, the lens having a circular cross-section corresponding to the cylindrical wall of the recess and a planar face bearing against the bottom of the recess; and a chip comprising terahertz components fabricated using semiconductor technology, the chip being centered in the orifice and fixed to the planar face of the lens. The chip may be fixed to the lens by an adhesive disposed in the interface between the chip and the lens. The adhesive may have the following characteristics: a) epoxy resin curable by heat; b) Brookfield viscosity CP51, 25° C., speed 5 rpm: 50000 mPa·s±20%; and c) absence of fillers to make the adhesive electrically or thermally conductive.

The adhesive may be designated commercially as Ablebond 84-3 or Loctite™ Ablestik 84-3.

The chip may comprise, on a face on the side opposite the lens, contacts connected by conductive wires to corresponding contacts of the support at the edge of the orifice, the contacts at the edge of the orifice being themselves connected to contacts at the periphery of the support by conductive tracks.

The second face of the support may comprise a well at the bottom of which is located the orifice with its peripheral contacts, the well being filled with a protective material for the conductive wires and the chip.

Also provided is a method for assembling an optical module for terahertz radiation, comprising the following steps: fabricating a support including a recess having a generally cylindrical wall opening onto a first face of the support, and an orifice centered on the cylindrical wall and passing through a bottom of the recess to a second face of the support; joining the support to a lens such that a circular cross-section of the lens centers with respect to the cylindrical wall of the recess and a planar face of the lens bears against the bottom of the recess; using an optical placement machine, centering in the orifice a chip comprising terahertz components fabricated using semiconductor technology; and fixing the chip to the planar face of the lens. The step of fixing the chip may comprise depositing an adhesive of the aforementioned type between a face of the chip and the planar face of the lens.

The step of joining the support to the lens may comprise the following steps: placing the lens in an orifice of a plate with its planar face facing upward; and placing the support on the planar face of the lens with an optical placement machine, whereby pressure exerted by the placement machine on the lens causes alignment of the planar face of the lens with the bottom of the recess.

The adhesive having the aforementioned characteristics may in fact be used to assemble any silicon elements serving to fabricate an optical device for terahertz radiation.

### BRIEF DESCRIPTION OF THE DRAWINGS

Embodiments will be set forth in the following description, given in a non-limiting manner in relation to the attached figures, among which:

FIG. 1 represents a sectional view of an embodiment of an optical module for a terahertz imager;

FIG. 2 is a perspective view of the optical module; and

FIG. 3 illustrates an assembly step for optical modules.

### DETAILED DESCRIPTION

To automate the assembly of chips onto any support, chips are generally manipulated by “pick and place” optical placement machines that are capable of placing the chips with precision relative to a visual reference mark on the support.

In the case of chips to be mounted in modules including a silicon lens, it turns out that the planar face of the lens intended to receive the chip offers very little contrast, even when patterns are engraved thereon, such that optical recognition by the placement machine is often defeated or altered. As a result, the chip is too often poorly centered in an automated production line.

Another difficulty lies in the optical quality of the interface between the chip and the lens. The adhesives available for bonding a silicon chip are generally intended for a support without optical transmission requirements (ceramic, metal or resin). It has been found that these adhesives do not have good terahertz wave transmission properties, whereby drops of adhesive are deposited at the periphery of the chip rather than in the interface. However, depending on the fluidity of the deposited adhesive, it manages to partially penetrate into the interface by capillarity, causing uneven bearing of the chip on the face of the lens and deterioration of the quality of terahertz wave transmission at the periphery of the sensor array.

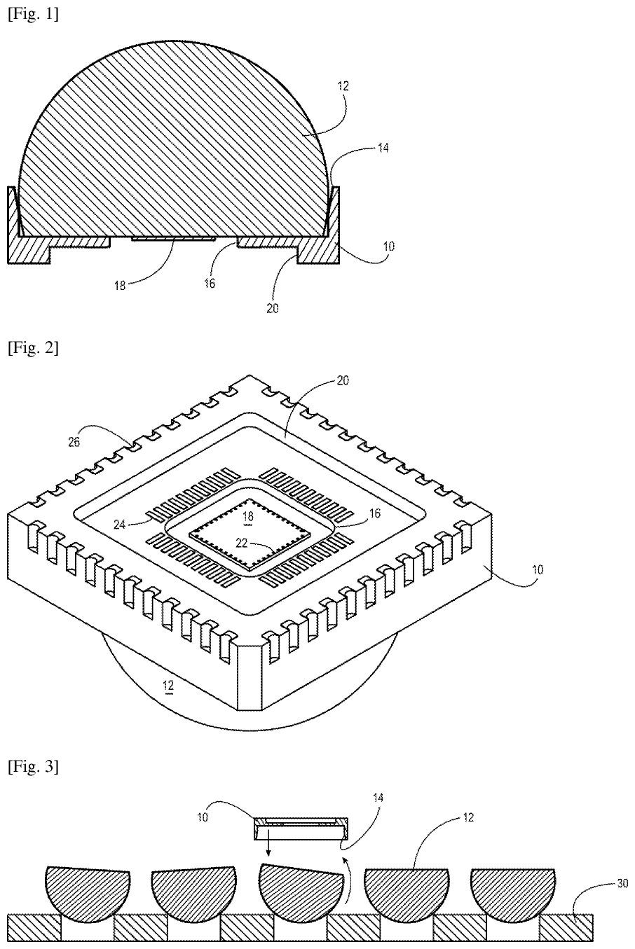

FIG. 1 represents a sectional view of an embodiment of an optical module for a terahertz imager that overcomes the difficulties of centering the chip relative to the lens.

The module comprises a support 10 that may be fabricated using multilayer printed circuit techniques. The support has a face designed to receive a silicon lens 12 with centering. The lens 12 is represented by way of example as hyper-hemispherical, which corresponds to the most common case, but it could have other shapes, generally having a circular cross-section.

More specifically, the face of the support intended to receive the lens, the upper face in the figure, comprises a recess having a generally cylindrical wall 14. The bottom of the recess is designed to receive the planar face of the lens in contact. The wall 14 has a diameter corresponding to the largest diameter of the lens 12. When the lens is hyper-hemispherical, as represented, the largest diameter (the equator) is located away from the planar face; in this case, the wall 14 may flare, as represented, to locally conform to the shape of the lens.

The bottom of the recess is pierced with an orifice 16 centered relative to the cylindrical wall 14 and open on the second face of the support, the lower face in the figure. A chip 18 comprising the terahertz components is fixed to the face of the lens 12, inside the orifice 16. By centering the chip 18 relative to the orifice 16 during its placement and fixing, precise centering of the chip relative to the lens 12 is obtained. This precision is ensured particularly by the dimension chain between the orifice 16 and the cylindrical wall 14, which involves a single part, in combination with the fact that optical recognition of the edges of the orifice 16 by the placement machine is particularly easy.

If by chance the fabrication process of the support is not very precise with regard to fabricating the edges of the orifice 16, the lower face of the support 10 may include conductive tracks serving as optical reference marks, particularly peripheral contacts of the orifice 16, represented below, serving to connect the chip to circuits of the support. Such reference marks can also be placed with precision relative to the cylindrical wall 14, and offer high contrast making optical recognition easy.

As represented, the lower face of the support 10 forms a well 20 at the bottom of which opens the orifice 16. This well may be filled with a protective material for the chip 18, once it is fixed and electrically connected to the support.

FIG. 2 is a bottom perspective view of the optical module of FIG. 1. This view reveals in particular the bottom of the well 20 and an example of an electrical connection structure for the chip 18. The visible face of the chip 18 may be its active face, i.e. the face on which the components and electrical contacts are fabricated. The terahertz radiation is then received by the components, for example an array of terahertz receivers, through the rear face of the chip. This active face comprises rows of peripheral contacts 22 that are connected by conductive wires (not shown) to respective contacts 24 of the support, arranged in rows at the edges of the orifice 16. These contacts 24 may also serve as precise reference marks for optical recognition by the placement machine.

The contacts 24 at the edge of the orifice are in turn connected to contacts 26 arranged at the periphery of the support by conductive tracks, not visible, fabricated for example in internal layers of the support in the case of a multilayer printed circuit.

The well 20 may be filled with a protective material that encapsulates the chip and the conductive wires.

FIG. 3 illustrates an assembly step for a batch of modules. The lenses 12 are arranged with their planar faces facing upward in circular orifices of a plate 30. The spherical portions of the lenses thus form ball joints allowing self-alignment. An adhesive dispensing machine deposits, for example, four drops of adhesive regularly spaced at the periphery of the planar face of each lens, for example, beyond the four straight edges of the orifice 16 of the supports to come. A placement machine then deposits the supports 10 on the lenses.

The dispensing and placement machines can locate themselves optically relative to the contour of the lenses. Even if the planar faces of the lenses are not necessarily horizontal, since the lenses are hyper-hemispherical, the contour perceived from above by the machines remains circular.

According to an alternative for aligning the machines on the lenses, they may be adjusted with the coordinates of the orifices of the plate, the plate and its orifices being machinable with precision.

In the placement phase for the supports 10, at the moment of contact of a support with the planar face of the corresponding lens, as illustrated for one of the lenses, the lens tilts in its orifice so that its planar face straightens and aligns with the bottom of the recess 14, and the lens centers between the cylindrical walls. In the preceding phase of depositing adhesive drops, it is possible that the lenses also tilt under the effect of contact with the nozzle of the dispensing machine, but the resulting misalignment is also corrected in the support placement phase.

Subsequently, with the supports 10 in place and centered relative to the lenses 12, the orifices 16 serve as optical reference marks for fixing the chips to the exposed portion of the planar faces of the lenses. The dispensing machine deposits adhesive at the locations for the chips, then the placement machine deposits the chips.

The modules are then transferred to an oven to cure the adhesive, then to a bonding station where conductive wires are bonded between the contacts 22, 24 of the chips and supports, and the wells 20 are filled with protective material. For these operations, it is preferable that the lenses no longer tilt. Thus, for example, the modules are previously transferred to a plate having orifices of larger diameter than the lenses, such that the supports 10 rest flat on the plate.

Fixing the chip 18 to the planar face of the lens 12 was attempted by direct bonding, namely by depositing a drop of adhesive at the interface between the chip and the lens. Although it is well known that this poses terahertz wave transmission problems, the inventors conducted various tests. These tests showed that most commercially available adhesives intended to fix chips onto a traditional support, generally metallic, did indeed significantly deteriorate terahertz wave transmission between the lens and the chip. However, a specific adhesive was revealed that offers satisfactory transmission characteristics. This is the adhesive designated commercially as Ablebond 84-3 or Loctite™ Ablestik 84-3.

This adhesive has the following characteristics that confer good properties for fabricating interfaces between silicon elements generally intended to perform optical functions in the terahertz domain:
Epoxy resin curable by heat.
Brookfield viscosity CP51, 25° C., speed 5 rpm: 50000 MPa·s.
Absence of fillers to make the adhesive electrically or thermally conductive. The aforementioned adhesive is electrically insulating.
Thermal Conductivity of 0.8 W/mK at 121° C., achievable without metallic fillers.

The most important characteristic is the absence of fillers that impair terahertz wave transmission, particularly metallic particles.

Viscosity is also important. The indicated value is intended to fabricate interfaces in liquid phase of 25 to 50 μm with a chamfer of 25 to 50% of the chip height. To obtain good terahertz wave transmission characteristics, an interface thinner than 25 μm is preferably targeted by increasing the pressure exerted on the chip at the time of its placement. The indicated viscosity value is sufficiently high, in this case, to avoid excessive flow under the chip that would leave voids at the interface, but sufficiently low not to have to exert too much pressure to fabricate interfaces less than 25 μm thick. The optimal viscosity value may vary within a certain margin around that indicated above, for example ±20%.

The base of the adhesive, here an epoxy resin curable by heat, proves to be suitable for silicon-on-silicon bonding and exhibits satisfactory terahertz wave transmission characteristics.

Thermal conductivity is less important, since the contemplated chips dissipate little power.

1. A method for assembling an optical device compatible with terahertz radiation, comprising the following steps:
providing a silicon lens (12) and a silicon chip including terahertz components (18), each having a planar face;
depositing on the planar face of the lens or of the chip an adhesive having the following characteristics:
epoxy resin curable by heat,
Brookfield viscosity CP51, 25° C., speed 5 rpm: 50000 mPa·s±20%, and
absence of fillers to make the adhesive electrically or thermally conductive; and
applying the planar face of the chip to the planar face of the lens.

2. Method according to claim 1, wherein the adhesive is designated commercially as Ablebond 84-3 or Loctite™ Ablestik 84-3.
